(19) United States
(12) Patent Application Publication
(10) Pub. No.: US 2018/0003180 A1
(43) Pub. Date: Jan. 4, 2018

(54) PUMPING ENERGY MANAGEMENT CONTROL SYSTEM

(71) Applicant: ONLINE ENERGY MANAGER LLC, Paoli, PA (US)

(72) Inventor: Sridharan Raghavachari, Franklin, WI (US)

(21) Appl. No.: 15/635,878

(22) Filed: Jun. 28, 2017

Related U.S. Application Data
(60) Provisional application No. 62/357,463, filed on Jul. 1, 2016.

(51) Int. Cl. F04D 15/00; F04D 13/14; G05B 15/02; G01F 1/34; F04D 1/00

(52) U.S. Cl. CPC F04D 15/0005; G05B 15/02; G01F 1/34; F04D 15/0088; F04D 15/0066; F04D 13/14; F04D 1/00

(57) ABSTRACT

A method includes receiving an power value for a first pump and a differential pressure across the first pump and receiving an power value for a second pump and a differential pressure across the second pump, wherein the first pump is in a first pumping line and the second pump is in a second pumping line that pumps in parallel with the first pumping line. The flows through the first pumping line and the second pumping line are adjusted to minimize an power per flow per differential pressure of the first and second pumping lines in combination.

### CROSS-REFERENCE TO RELATED APPLICATIONS

This U.S. Patent Application is based on and claims the benefit of U.S. Provisional Patent Application No. 62/357,463, filed Jul. 1, 2016; the content of which is hereby incorporated by reference in its entirety.

### BACKGROUND

Pumping equipment are in the family of machineries, which are used to transport non-compressible fluids (liquids) such as water, petroleum products (petrol, diesel, crude oil etc.) from one place to another for end users. It is common knowledge that water is the most-pumped fluid in the world. Electrical energy or mechanical energy is used to power the prime movers to drive the pumps. The pumps convert the energy imparted from the prime movers into kinetic (velocity) and differential pressure energy in the fluid enabling transportation of fluid from one place to another.

The discussion above is merely provided for general background information and is not intended to be used as an aid in determining the scope of the claimed subject matter.

### SUMMARY

A novel pumping energy management control system is provided, including an energy management controller device, a pumping system, and associated methods, according to various embodiments. In one illustrative embodiment, a pumping energy management controller device includes one or more signal connections, one or more electronic memory elements, and one or more processors. The controller device has access to resources that are either stored on the electronic memory elements or are accessible via the signal connections directly or indirectly. The resources include an equipment data table, equipment and operational configuration table, an operational efficiency matrix, and executable instructions. The processor determines operational control signals for energy efficient operation of a pumping system, based on sensor inputs from the pumping system, and on data from the equipment data table, the equipment and operational configuration table, and the operational efficiency matrix; and provides the operational control signals via the signal connections.

A method includes receiving a power value for a first pump and a differential pressure across the first pump and receiving a power value for a second pump and a differential pressure across the second pump, wherein the first pump is in a first pumping line and the second pump is in a second pumping line that pumps in parallel with the first pumping line. The flows through the first pumping line and the second pumping line are adjusted to minimize a power per flow per differential pressure of the first and second pumping lines in combination.

A pumping station includes at least two pumping lines in parallel with each other. Each pumping line includes a pump, a flow control valve having a first side located at a discharge of the pump and a second side, a first pressure sensor at an inlet to the pump, a second pressure sensor at the discharge of the pump, a third pressure sensor at the second side of the flow control valve, and a power sensor that senses the power used by the pump. A controller device receives sensor values from each of the first pressure sensors, second pressure sensors, third pressure sensors and power sensors and uses the sensor values to control flow in the at least two pumping lines to minimize power usage.

A controller device for controlling a parallel pumping installation includes a memory, input interfaces, output interfaces and a processor. The memory contains processor instructions and parameters for each of a plurality of pumps and each of a plurality of flow control valves in the parallel pumping installation, the parameters indicating which of a plurality of parallel pumping lines each pump and each flow control valve are installed in. The input interfaces receive pressure sensor values from pressure sensors mounted on each side of each pump and on each side of each flow control valve and receive power sensor values from power sensors coupled to each pump motor. The output interfaces are in communication with at least one of a pump and a flow control valve such that output signals can be sent from the controller device to at least one of the pump and the flow control valve to set the flow in at least one pumping line. The processor uses the parameters for the pumps and the flow control valves and the sensor values from the pressure sensors and the power sensors to set the flow in at least one pumping line to thereby minimize the power usage of the parallel pumping installation for a particular pumping flow and pumping head.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is schematic of a pumping and distribution system.

FIG. 2 is a schematic of a pumping station of the prior art.

FIG. 3 is a graph of head and flow for a pumping station over the course of a day.

FIG. 4 is a schematic of a pumping station in accordance with one embodiment.

FIG. 5 is a flow diagram of a method of minimizing power usage in accordance with one embodiment.

FIG. 6 is a graph comparing power usage of the prior art and one embodiment over the course of a day.

FIG. 7 is a block diagram of a Programmable Logic Controller that can be used as the controller device in accordance with one embodiment.

### DETAILED DESCRIPTION OF ILLUSTRATIVE EMBODIMENTS

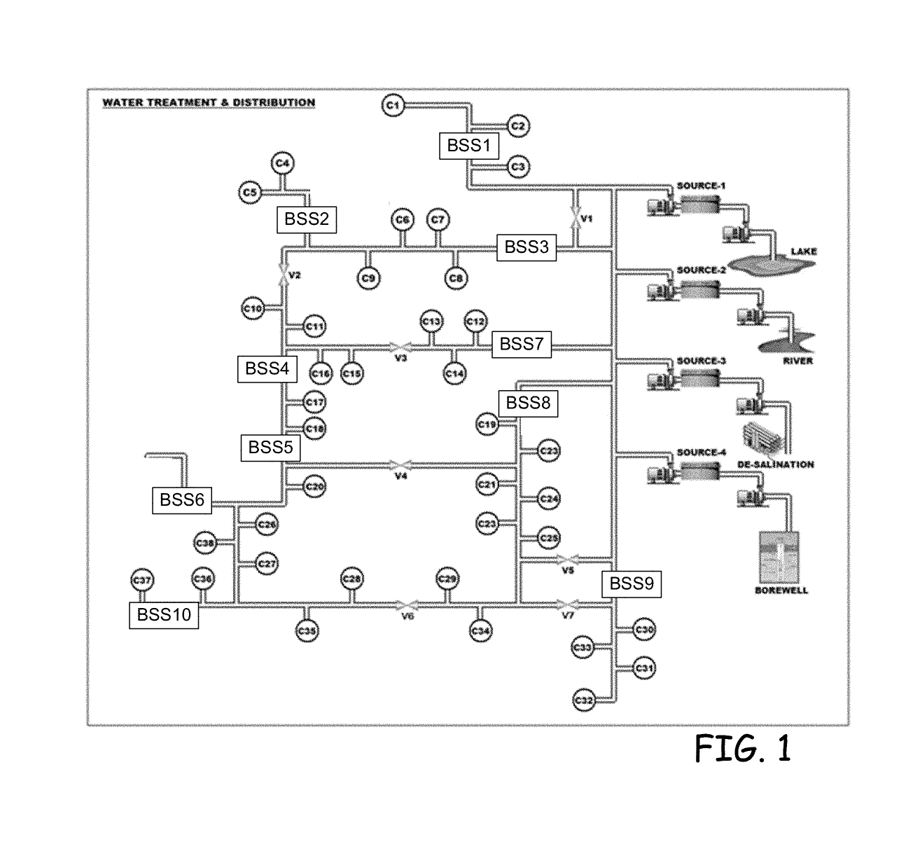

FIG. 1 depicts a pumping and distribution system, or more simply referred to as a pumping system. The pumping system of FIG. 1 includes 1) fresh water sources & associated water treatment plants (WTP) such as lakes+WTP (source 1), rivers+(WTP) (source 2), desalination plants (source 3), bore wells+WTP (source 4) etc., 2) piping for distribution, 3) Isolation, distribution, and/or balancing valves such as V1, V2, V3, V4 etc., 4) Booster Pumping stations such as BSS1, BSS2, etc., all interconnected with each other as upstream & downstream booster stations, 5) distribution piping networks for individual communities represented by C1-C37.

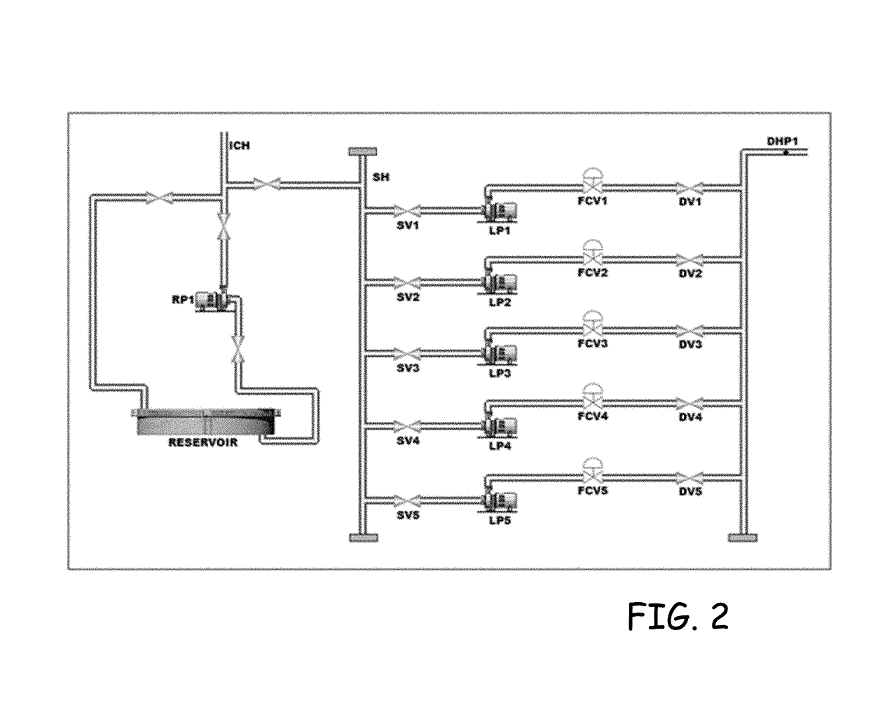

FIG. 2 provides a schematic diagram of a prior art pumping station. Water enters the pumping station through an incoming header (ICH). The ICH is piped in such a way it can directly feed a suction header SH or a reservoir tank. The ICH can originate from an upstream booster station or a water treatment plant. There are several booster stations all interconnected such as in the exemplary water distribution system of FIG. 1. The water from the suction header SH is sucked by one or more of the Line pumps LP1-LP5 and discharged at a higher pressure to the discharge header DH of the booster station for onward distribution to the various communities.

Line pumps LP1-LP5 are connected in parallel between the suction header and the discharge header. For single-speed pumps, a flow control valve FCV is provided that controls the amount of flow on the line when the pump is operating. For Variable Frequency Drive pumps, the amount of flow in the line is controlled by adjusting the speed of the pump. In general, the booster station has a target output pressure for DH and an operator of the booster station, either a person or an automatic control unit, adjusts the flows in the various lines to achieve that target pressure.

As communities downstream from the booster station draw more water from the system, the pressure in the discharge header will decrease if the flow through the lines is kept constant. Currently, the pressure in the discharge header is measured and when it begins to decrease, the flow in one or more of the lines is increased. In general, the flow provided by any currently running pumps is first increased to meet the increased demand of the communities. When the currently running pumps are operating at maximum flow and the pressure continues to drop, a pump in one of the other lines is started and the flow of the added pump line is adjusted until the target pressure is reached.

Let us consider two different conditions of flow demand emanating from the discharge header at a Time 1 and a Time 2 using identical single-speed pumps in each line of FIG. 2, where each pump has a maximum flow rate of 10,000 GPM at 140 PSIG at the discharge header.

Discharge Pressure Set Point for both the times: 140 PSIG

Time 1:
Discharge Pressure—DHP 1-140 PSIG
Flow to communities-8000 GPM as measured in communities

Time 2:=Time 1+5 Minutes (sample interval)
Discharge Pressure—DHP 1-130 PSIG
Flow to communities-14,000 GPM as measured in communities

Under the prior art control strategy the controller monitors only the pressure at the discharge header. Typically the controller is designed and programmed to maintain the discharge pressure either manually or automatically to the target pressure of 140 PSIG.

The controller does not know the flow has increased to 14,000 GPM because it neither measures the flow at the header nor gets the feedback of the measurement of flow from the communities.

But in time 2 the controller reads the pressure as 130 PSIG.

In this case because the actual flow was 8,000 GPM in Time 1, one pump was running putting out 80% of its full design flow to maintain the header pressure at 140 PSIG.

The flow demand has increased to 14,000 GPM in a matter of five minutes at a rate of increase of 1,200 GPM. The increased flow rate was not met by the supply from the discharge header. Therefore the pressure drops to 130 PSIG at Time 2.

The flow increase and the resultant drop in pressure could have occurred in less than the sampling time.

The controller is programmed to increase the flow capacities of the running pump to bring the DH pressure back to 140 PSIG.

Since only one pump was running at 80% of capacity in Time 1, the first action the controller takes is to increase the flow output from the line of the running pump either by increasing the speed of the pump in case of a Variable Frequency Drive (VFD) pump or setting the control valve FCV to a full open position.

In either case, the line will put out a maximum of 10,000 GPM because that is the full capacity of the running pump. As a result, the pressure will not still reach the target of 140 PSIG because the demand increase (to 14,000 GPM) is not yet met by the supply.

The controller then opens another line and starts the respective line pump.

However, when the new pump is started, an imbalance of the system flow occurs resulting in an over powering of the system. For example, in the example above using 1000 HP pumps rated for 746 KW, the power drawn for a million gallons @ 95 PSIG of ΔP was found to be 900 kW which translates to 0.95 kW/1000 GPM/PSI of ΔP. The industry norm for a pumping system of constant volume pumping is 0.6 kW/1000 GPM/PSI of ΔP. This represents an over powering of 58% that the present Inventors believe is occurring due to the mutual resistance (dead-heading) provided by the pumps running in parallel in the system.

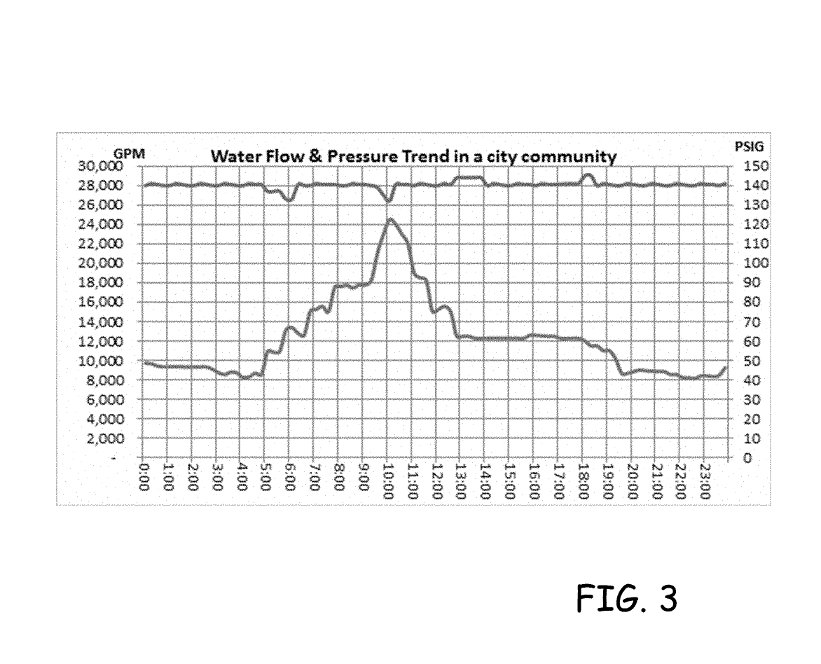

FIG. 3 provides a graph showing changes in the output flow and power usage of a booster station of the prior art over the course of a day. It is to be noted that around 5:00 AM the flow demand crosses 10,000 GPM (One pump) to slightly more than 10,000 say 11,000 GPM requiring two pumps in parallel. The increase is 2500 GPM from 8500 to 11,000 GPM, an increase in flow of about 30%. But the power consumption increases from 600 kW to 1,100 kW, an increase of 83%.

The purpose of the present embodiments is to optimize the pumping power (energy=power*time) while using the pumps to transfer water or any other non-compressible fluids from one place to another for end users. Typical pumps used are centrifugal type. The pumps may be of several different configuration such as horizontal, vertical, submersible, above ground, horizontal or vertical split casing, open or closed impellers etc . . . . All centrifugal pumps are covered by the invention. The disclosure and the applications take an illustrative example of water treatment and distribution system. One embodiment is applicable to all pumping systems used for non-compressible fluids. The pumps may be fitted with Variable Frequency Drives or may include a Flow Control Valve or both to control the flow rate.

An exemplary goal of one or more embodiments is to reduce or eliminate over powering in fluid pumping especially involving parallel pumping configuration.

Pumping Power
Power required for Pumping water
BHP=Q*ΔP/3960,
Where:
“BHP” is the Break Horse Power (Power at the shaft)
“Q” is the flow in Gallons per minute
“ΔP” is the differential pressure Discharge Pressure minus the Suction Pressure in feet of water column (ΔP in PSIG*2.31)
BHP=IHP*ηp*ηm,
Where:
“IHP” is the Indicated Horse Power
“ηp” is the pump efficiency (assumed as 82%)
“ηm” is the motor efficiency (assumed as 90%)
kW=IHP*0.746,
Where:
kW is the Power at the utility meter

Note: Similar formulas are available for other non-compressible fluids based on the respective specific gravities.

As seen from the above formulae, Power Requirement (HP/kW) is proportional to the flow & differential pressure. In one embodiment, the differential pressure across each pump is optimized.

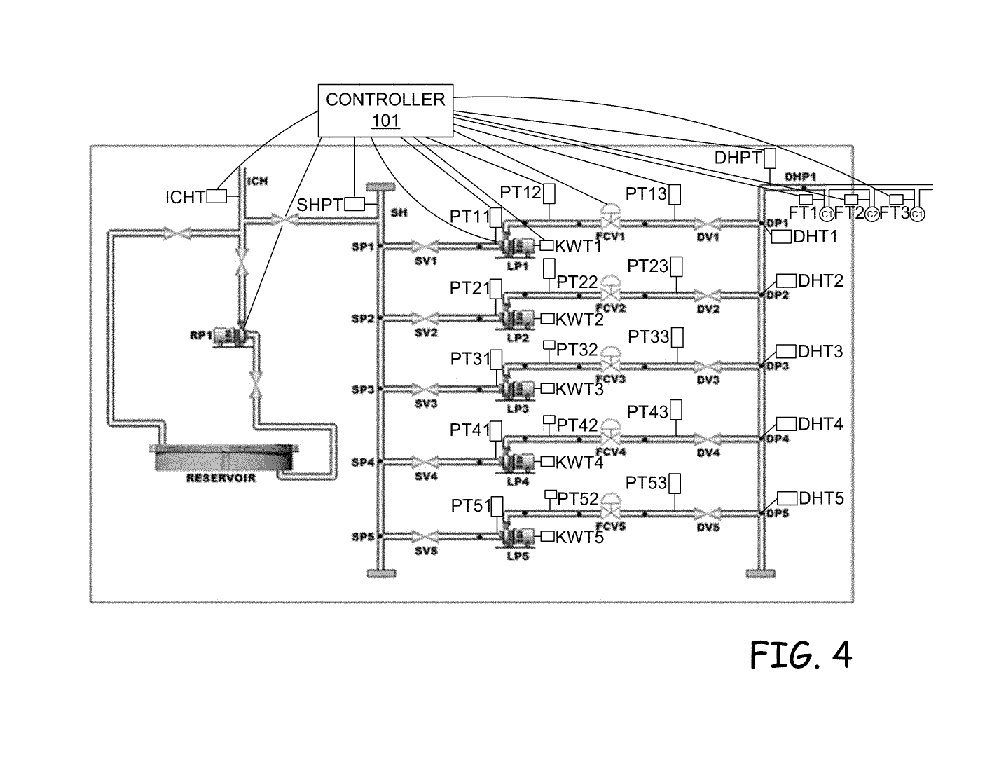

FIG. 4 provides a schematic diagram of a booster station in accordance with one embodiment. In FIG. 4 five parallel pumping lines branch off perpendicular from the suction header. Each branch includes a suction shut off valve SV1-SV5, respectively, a line pump LP1-LP5, a flow control valve FCV1-FCV5 and a discharge shut off valve DV1-DV5 all in series, respectively, in the order mentioned. The pumps may be constant speed pumps and/or variable speed pumps driven by variable frequency drives. The flow control valves may be plug or ball or cone type of valves. The line pipe connects to the main discharge header DH after the shut off valve. Each booster station may have two or more lines running parallel to each other starting from the SH to the DH.

The discharge header of the booster station connects various communities C1, C2 and C3 that use one or more valves (not shown) to control the flow of water to the communities.

A pumping energy management controller device 101, or more simply referred to as energy management controller device 101 or controller device 101, generally accepts various inputs from different system components and sensors, processes those inputs together with data stored on the controller device, and generates output control signals that are sent to different system components to control their functioning to achieve a desired target pressure in an energy-efficient manner.

Whereas prior art controls focus on meeting user-selected pressure requirements in a pumping system with very little or no sophistication in optimizing for energy efficiency, one illustrative advantage of pumping energy management controller device 101 includes both delivering user-selected pumping performance and actively optimizing for energy efficiency in delivering that pumping performance in a pumping system, in one illustrative embodiment.

The sensors connected to controller device 101 include pressure sensor transmitters at the suction end (inlet) and discharge end (outlet) of each pump such as pressure sensors transmitters PT11 and PT12 for line 1 in FIG. 4. A pressure sensor transmitter, such as PT13, is also provided at the outlet side of each control valve. In some embodiments, a pressure sensor transmitter, such as DHT1, is provided at the T-junction between each line and the discharge header. The pressure sensor transmitters and flow transmitters of each community line are also connected to controller device 101 and provide pressure and flow values for the water going to each community. Pressure sensors DHPT and SHPT are also provided to give a pressure value for the discharge header and the suction header, respectively, to controller device 101. In some embodiments, a pressure sensor is also provided on incoming header ICH. Lastly, power sensors provide the electrical power usage of each pump to controller device 101. For example power sensor KWT1 provides the electrical power used by pump LP1.

In some embodiments, controller device 101 is part of a Local Control System located in the booster station while in other embodiments controller device 101 is part of a Centralized Control System located outside of the booster station. Communication between controller device 101 and the sensors, pumps and valves may wired or wireless using any type of suitable communication protocol.

The various embodiments differ from the prior art in that the prior art is only concerned with the pressure difference “DHP−SHP” between the discharge header and the suction header. In the various embodiments, the differential pressure across each pump, such as “PT12−PT11” is measured. The present inventor believes this removes two errors in determining the pressure across each pump. The first error is the pressure drop across valve SV and the second error is the pressure drop across valves FCV and DV.

By measuring the pressure at PT12 and PT11 the various embodiments eliminate the two errors above.

One embodiment includes the following data acquisition or mappings in controller device 101:
Configuration of all equipment including electrical distribution system
Pump specifications & characteristics of all the pumps in the system
Motor specification and characteristics of all the motors
Variable Frequency specifications and characteristics of all the VFDs in the system
Valve Characteristics of the all the valves in the system
Data mappings of all the field feed backs including Flow Meter readings from all the communities as well from the Water Treatment Plants
Analog and digital data of all the existing and new instruments
Historical data on demand for both electricity and water, pressures, flows etc.
The pumping lines that each pump and each Flow Control Valve are located in.

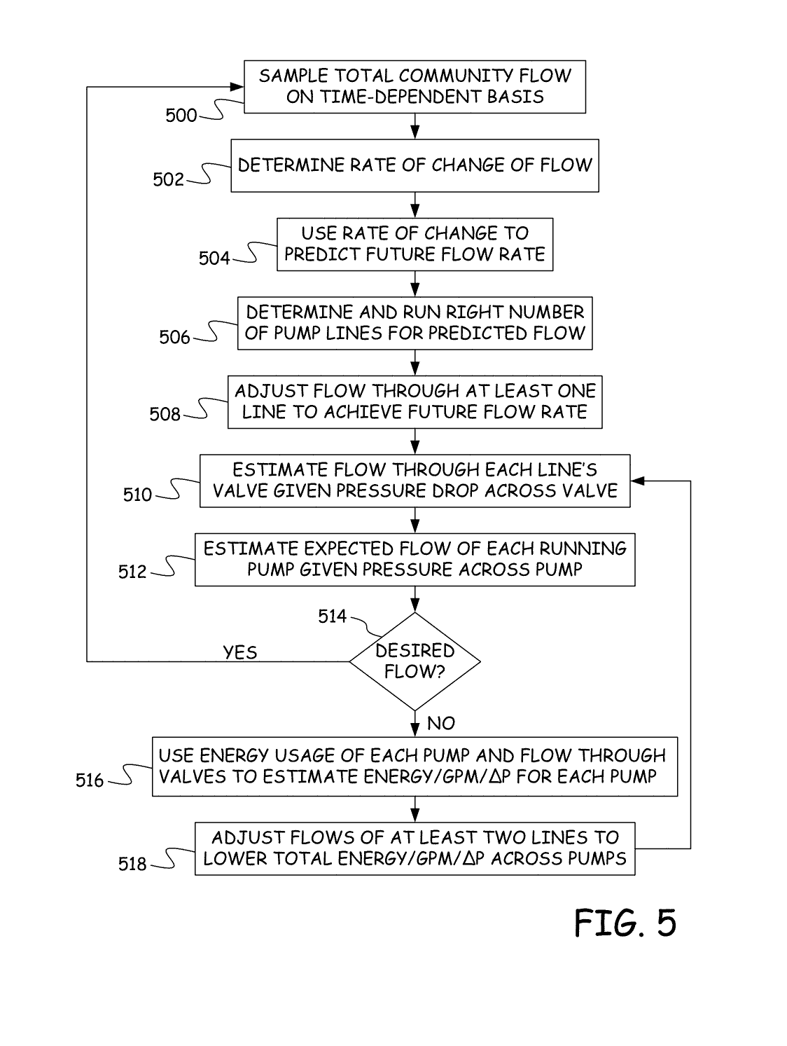

FIG. 5 provides a flow diagram of a method of adjusting pump speed in accordance with one embodiment. In step 500, the total community flow of the communities serviced by the booster station is sampled on a time-dependent basis such that samples are taken more often when changes are expected. The rate of change of the total community flow is determined at step 502 and is used at step 504 to predict the future flow rate. This prediction is made because it can take between two and five minutes to bring a new pump up to speed. At step 506, the number of pumps needed to provide the future flow rate at the target header pressure is determined and if an additional pump or pumps is needed, the additional pumps are started. At step 508, the flow through the lines is adjusted to achieve the predicted flow rate for the communities.

At step 510, the flow through each line is estimated using the pressure drop across the flow control valve (FCV) of the line. In accordance with one embodiment, the flow through the flow control valve is determined using:

Q=Cv/\sqrt{SG/ΔP},

where Q is the flow in GPM (to be determined), Cv is the valve coefficient for the FCV, SG is the specific gravity of the fluid, and ΔP is the pressure difference across the valve as determined from PT13−PT12. For example: Cv=1000, SG=1, ΔP=4 PSI, the flow is 16,000 GPM.

At step 512, an expected flow of each running pump given the pressure across the pump and the power usage of the pump is determined. In accordance with one embodiment, the expected flow is determined as:

Q=(kW/0.746)*ηm*ηp*3960/ΔP,

where kW is the electric demand of the pump's motor (e.g. 1200 kW), ηm is the motor efficiency (e.g. 92%), ηp is the pump efficiency (e.g. 85%) and ΔP is the differential head in feet (e.g. 231 feet) between the inlet and discharge of the pump. For example, for a pump operating at 1200 kW with a motor efficiency of 92% and a pump efficiency of 85% that is producing a differential head of 231 feet, the expected flow through the pump is Q=21,500 GPM.

At step 514, controller 101 determines if the flow through the valve of each line and the expected flow of each running pump match desired flows. If the flows are not as desired, controller 101 proceeds to step 516 where it uses the power usage of each pump and the flow through the valves to estimate the power/Gallons Per Minute/ΔP of each pump and the total power/GPM/ΔP of the booster station. At step 518, the flow of at least two lines is adjusted to lower the total power/GPM/ΔP of the booster station. For example, the flow in a line that was initially running close to the discharge of the header is reduced while the flow of a line that was recently started and is further from the discharge of the header is increased.

The process then returns to step 510 and steps 512, 514, 516 and 518 are repeated until the total power/GPM/ΔP has been minimized. When the flows are the desired flows at step 514, the process returns to step 500 to acquire additional samples of the community flow.

In accordance with one embodiment, the present inventors believe that large differences in flow estimates of the valve in a line and the pump in the line determined at steps 510 and 512 indicate that whatever flow the pump is putting out is being blocked at the junction of the line to the header by an opposing pressure namely the flow and pressure from a parallel pump which is much higher than those of the line under discussion. This phenomenon is termed dead heading which makes the system very inefficient.

Using the present embodiments, it is estimated that a prior art system that pumped 17,804,000 Gallons/Day and consumed 25,575 kWh/Day could be improved to pump the same amount of water using only 17,000 kWh/day—an power savings of 34%.

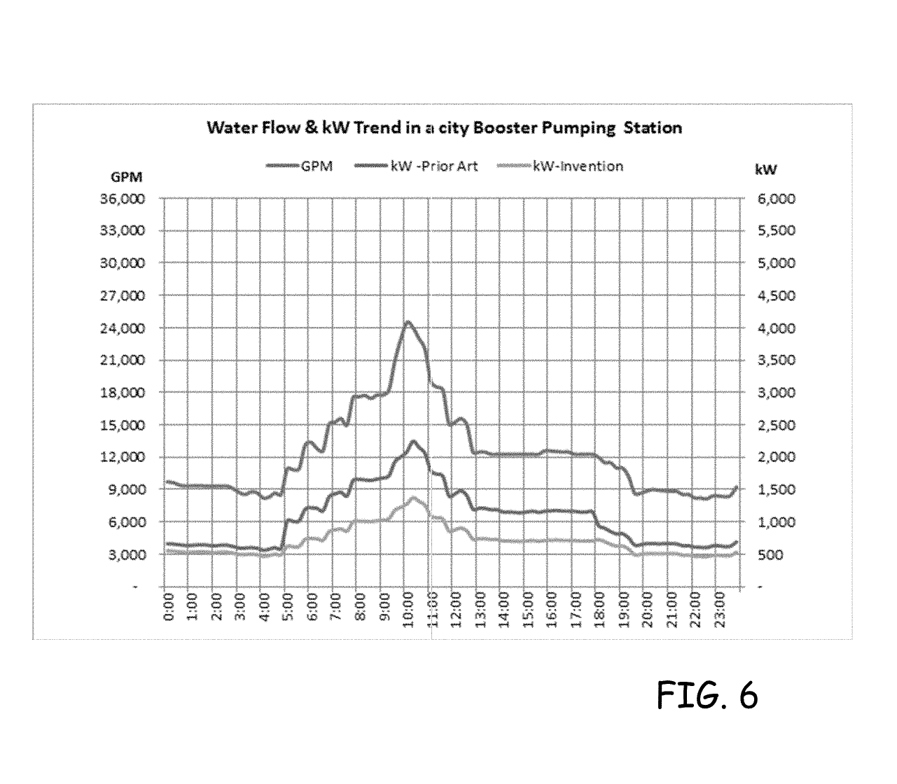

FIG. 6 provides a graph of the estimated GPM and kW usage over time for the prior art and for the various embodiments. The difference in power consumption between the prior art and the various embodiments is smaller when single pump is operating up to around 5 AM and after 8 PM. But the difference is very significant when parallel pumps are in operation.

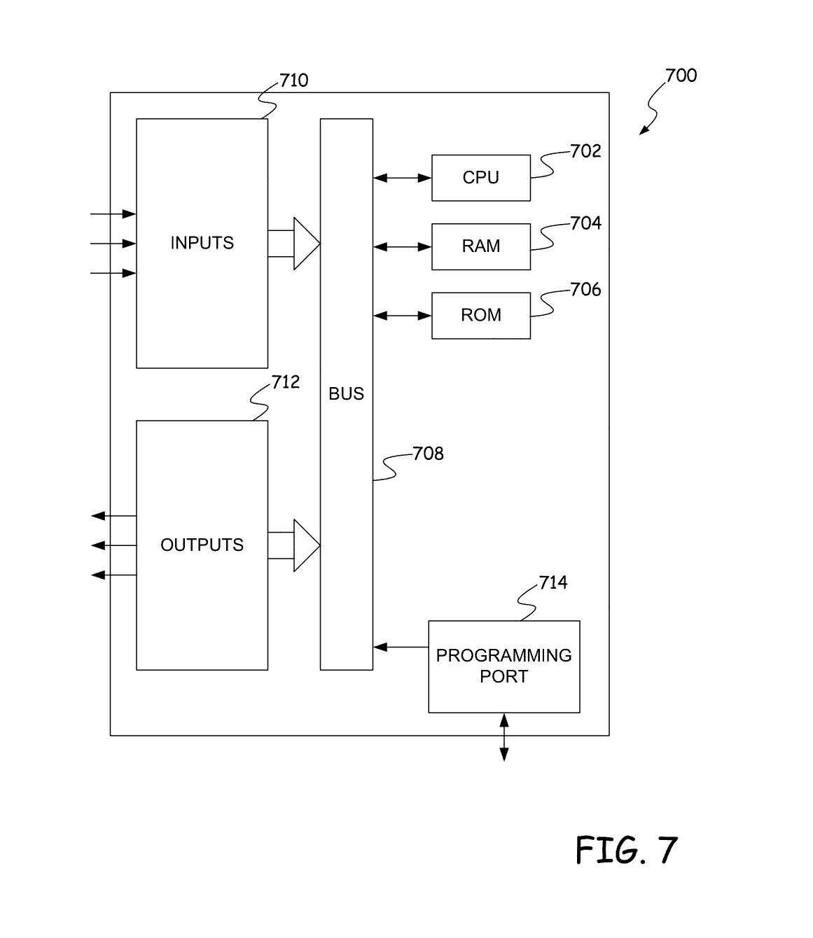

FIG. 7 provides a block diagram of a Programmable Logic Controller (PLC) 700 that can be used as controller device 101. PLC 700 includes a Central Processing Unit (CPU) 702 that communicates with a Random Access Memory (RAM) 704 and a Read Only Memory (ROM) 706 over a bus 708. CPU 702 executes instructions stored in RAM 704 and ROM 706 generate outputs through a collection of output interfaces 712 based on inputs received through a set of input interfaces 710. The inputs can include signals from the various pressure, flow and power meter discussed above, for example, and the outputs can include switch controls that turn pumps on and off, variable frequency signals that control the speed of VFD pumps, and valve control signals that control the degree to which a valve is open, for example. Some of the instructions executed by CPU 702 may be loaded onto PLC 700 through a programming port 714 and stored in RAM 704. These instructions include instructions used to implement the method of FIG. 5 discussed above.

Although the discussion above refers to a booster station, the embodiments described above may be used in any pumping station in which parallel pumping is used, such as pumping stations located at a water source or water treatment plant, for example.

Although the present invention has been described with reference to preferred embodiments, workers skilled in the art will recognize that changes may be made in form and detail without departing from the spirit and scope of the invention.

What is claimed is:

1. A method comprising:
receiving a power value for a first pump and a differential pressure across the first pump;
receiving an power value for a second pump and a differential pressure across the second pump, wherein the first pump is in a first pumping line and the second pump is in a second pumping line that pumps in parallel with the first pumping line;
adjusting a flow through the first pumping line and a flow through the second pumping line to minimize an power per flow per differential pressure of the first and second pumping lines in combination.

2. The method of claim 1 further comprising:
receiving a differential pressure across a flow control valve in the first pumping line;
using the differential pressure across the flow control valve to determine a flow through the flow control valve;
using the differential pressure across the pump to determine an expected flow for the pump; and
using the flow through the valve and the expected flow for the pump to determine which pumping lines to adjust;

3. The method of claim 1 further comprising:
initially running the first pump while keeping the second pump idle;
receiving flow values for pipes serviced by the first pumping line and the second pumping line;
determining that the changing flow values are such that the first pump soon will not be able to provide enough flow at a desired head;
starting the second pump while adjusting the flow through the first pumping line and the second pumping line to minimize power per flow per differential pressure of the first and second pumping lines in combination.

4. The method of claim 1 wherein the first pumping line and the second pumping line are part of a booster station.

5. The method of claim 4 wherein the booster station further comprises a third pumping line in parallel with the first pumping line and the second pumping line and the method further comprises:
receiving an power value for a third pump and a differential pressure across the third pump in the third pumping line;
adjusting the flow through the first pumping line, the second pumping line and the third pumping line to minimize the power per flow per differential pressure of the first, second and third pumping lines in combination.

6. The method of claim 1 wherein adjusting the flow reduces dead head resistance in at least one pumping line.

7. A pumping station comprising:
at least two pumping lines in parallel with each other, each pumping line comprising:
a pump;
a flow control valve having a first side located at a discharge of the pump and a second side;
a first pressure sensor at an inlet to the pump;
a second pressure sensor at the discharge of the pump;
a third pressure sensor at the second side of the flow control valve; and
a power sensor that senses the power used by the pump; and
a controller device that receives sensor values from each of the first pressure sensors, second pressure sensors, third pressure sensors and power sensors and uses the sensor values to control flow in the at least two pumping lines to minimize power usage.

8. The pumping station of claim 7 wherein the controller device determines an expected flow through the pump of a pumping line based on sensor values from the first pressure sensor for the pumping line, the second pressure sensor for the pumping line, and the power sensor for the pump in the pumping line.

9. The pumping station of claim 8 wherein the controller device determines a flow through the flow control valve of a pumping line based on sensor values from the second pressure sensor and the third pressure sensor.

10. The pumping station of claim 9 wherein the controller device determines a difference in the expected flow of the pump and the flow through the control valve and uses the difference to identify that the flow through a pumping line needs to be adjusted.

11. The pumping station of claim 9 wherein the controller device adjusts the flow through at least one pumping line to reduce a dead head effect on at least one pumping line.

12. The pumping station of claim 7 wherein the controller further receives flow sensor values indicative of flow in at least one conduit serviced by the pumping station and wherein the controller predicts a future needed flow based on the received flow sensor values.

13. The pumping station of claim 11 wherein the controller starts a pump in a pumping line based on the future needed flow.

14. The pumping station of claim 12 wherein the controller samples the flow sensor values on a time-dependent basis such that the flow sensor values are sampled more often when flow changes are expected.

15. A controller device for controlling a parallel pumping installation, the controller device comprising:
memory containing processor instructions and parameters for each of a plurality of pumps and each of a plurality of flow control valves in the parallel pumping installation, the parameters indicating which of a plurality of parallel pumping lines each pump and each flow control valve are installed in;
input interfaces that receive pressure sensor values from pressure sensors mounted on each side of each pump and on each side of each flow control valve and that receives power sensor values from power sensors coupled to each pump;
output interfaces that are in communication with at least one of a pump and a flow control valve such that output signals can be sent from the controller device to at least one of the pump and the flow control valve to set the flow in at least one pumping line; and
a processor that uses the parameters for the pumps and the flow control valves and the sensor values from the pressure sensors and the power sensors to set the flow in at least one pumping line to thereby minimize the power usage of the parallel pumping installation for a particular pumping flow and pumping head.

16. The controller device of claim 15 wherein the processor sets the flow to reduce dead heading in the parallel pumping installation.

17. The controller device of claim 15 wherein the processor identifies a need for an additional pump to be started and as the flow through the additional pump reaches a particular level, reduces the flow through a second pumping line.

18. The controller device of claim 17 wherein the processor identifies the need for an additional pump by receiving flow sensor values from flow sensors downstream from the pumping installation and predicting a future flow from the received flow sensor values.

19. The controller device of claim 15 wherein the processor minimizes the power usage per GPM of flow per unit of head for the parallel pumping installation.

20. The controller device of claim 15 wherein the processor sets the flow in at least one line by adjusting the speed of at least one pump.
